(19) United States
(12) Patent Application Publication
(10) Pub. No.: US 2014/0370153 A1
(43) Pub. Date: Dec. 18, 2014

(54) CONCENTRATED LOW WATER ACTIVITY LIQUID HUMAN MILK FORTIFIER INCLUDING EXTENSIVELY HYDROLYZED PROTEIN

(71) Applicant: ABBOT LABORATORIES, ABBOT PARK, IL (US)

(72) Inventors: MUSTAFA VURMA, Dublin, OH (US); KEVIN B. MAHAN, Dublin, OH (US); JEFFREY M. BOFF, Dublin, OH (US)

(73) Assignee: ABBOTT LABORATORIES, ABBOTT PARK, IL (US)

(21) Appl. No.: 14/369,803

(22) PCT Filed: Nov. 21, 2012
(86) PCT No.: PCT/US12/66222

§ 371 Date: Jun. 30, 2014

Related U.S. Application Data
(60) Provisional application No. 61/581,637, filed on Dec. 30, 2011.
(60) Provisional application No. 61/581,636, filed on Dec. 30, 2011.

(51) Int. Cl. A23C 9/20; A23C 9/152

(52) U.S. Cl. CPC A23C 9/206; A23C 9/1526; A23C 9/152
USPC 426/61; 426/590; 426/72; 426/580

(57) ABSTRACT

Disclosed are concentrated liquid human milk fortifiers including extensively hydrolyzed casein, and optionally a probiotic. The concentrated liquid human milk fortifier has a low water activity and a low pH, thereby reducing microbial growth in the fortifier.

### CROSS REFERENCE TO RELATED APPLICATIONS

The present application hereby claims the benefit of the provisional patent applications, Ser. Nos. 61/581,636; and 61/581,637, filed on Dec. 30, 2011, the disclosures of which are incorporated by reference herein in their entirety.

### FIELD OF THE DISCLOSURE

The present disclosure relates to a stable, concentrated liquid human milk fortifier. More particularly, the present disclosure relates to a long term stable, concentrated liquid human milk fortifier having a low water activity, and in some embodiments, a low pH. The concentrated liquid human milk fortifier may additionally includes extensively hydrolyzed casein, a high solids content, and a probiotic.

### BACKGROUND

Human milk is generally recognized as an ideal feeding for most infants due to its overall nutritional composition. Human milk provides infants with unique immunologic and developmental benefits as compared generally to commercially available infant formulas. For some infants, however, especially preterm infants, human milk does not always meet the complete nutritional needs. Although these infants still generally benefit from human milk, it is often desirable to supplement their human milk feedings with additional nutrients. Initially, these preterm infants may grow more rapidly than many of their term counterparts, and accelerated growth often requires additional nutrition, which is made possible by the use of a human milk fortifier in combination with human milk.

Further, some infants, and especially preterm infants whose digestive tracts are immature, experience a delayed and abnormal pattern of gut colonization, particularly with regard to probiotics such as bifidobacteria and lactobacilli. This impaired intestinal colonization may predispose preterm infants to necrotizing enterocolitis (NEC) and increase the risk of bacterial translocation.

Most of the human milk fortifiers described in the literature and commercially available have been formulated as reconstitutable powders rather than liquids in order to minimize the volume displacement of human milk by the fortifier. The fortifiers may additional include probiotics. As probiotics are living organisms, addition of probiotics to a liquid formula risks inconsistent bacterial levels due to undesired proliferation followed by die-off over time. Undesired proliferation of probiotic microorganisms will negatively affect the nutritional profile and physical stability of the final product.

Recently, however, liquid human milk fortifiers, and specifically highly concentrated human milk fortifier liquids, have received more attention as an alternative to powders. Although these highly concentrated liquid human milk fortifiers do generally displace slightly more volume than the conventional powders, the liquids have the significant benefit of being commercially sterile as they can be subjected to sufficient heat treatment during manufacturing, including optional aseptic manufacturing for sterility.

Due to sensitive digestive systems and poor tolerance in many preterm infants, it may be advantageous to utilize hydrolyzed proteins in human milk fortifiers. However, as compared to intact proteins, extensively hydrolyzed proteins (i.e., proteins having a degree of hydrolysis of about 20% or more) tend to have poor ability to form long term stable emulsions. Additionally, the presence of high levels of insoluble minerals such as calcium salts may also cause a number of stability issues when used in combination with extensively hydrolyzed proteins. As such, manufacturing long term stable concentrated liquid human milk fortifiers including extensively hydrolyzed proteins has proven difficult.

Many liquid human milk fortifiers have been manufactured with stabilizers, such as carrageenan. The stabilizers act to hold the nutrients and insolubles in solution over time and thus improve long term stability of the product. Although stabilizers such as carrageenan have generally proven to retard precipitation of many ingredients in the liquid nutritional formulations, this type of stabilizer is not permitted in infant formulas and human milk fortifiers in many countries around the world. When stabilizers cannot be used in highly concentrated human milk fortifiers, it can be very difficult to produce a long term stable highly concentrated human milk fortifier.

As such, there is a need for highly concentrated low water activity liquid human milk fortifiers that are sufficiently long term stable that include hypoallergenic proteins, such as extensively hydrolyzed casein proteins, and optionally probiiotics. Additionally, it would be very beneficial if the highly concentrated low water activity human milk fortifier could be formulated to provide additional macro- and micro-nutrients without unwanted mineral fallout during storage.

### BRIEF SUMMARY

The present disclosure is directed to long term stable high solids content and low water activity liquid human milk fortifiers including extensively hydrolyzed casein. In some embodiments, the extensively hydrolyzed casein is the sole source of protein in the concentrated liquid human milk fortifier. The concentrated liquid human milk fortifiers may be, in some embodiments, hypoallergenic. Because the liquid human milk fortifiers of the present disclosure have a high solids content and low water activity, their volume displacement when mixed with human breast milk and/or infant formula is minimized and their sterility is increased.

The present disclosure is specifically directed to a concentrated liquid human milk fortifier comprising from about 5% to about 50% by weight protein, on a dry weight basis, and optionally a probiotic. At least a portion of the protein is extensively hydrolyzed casein. The concentrated liquid human milk fortifier has a solids content of greater than 50% by weight and has a water activity of less than 0.90.

The present disclosure is further specifically directed to an aseptically-sterilized concentrated liquid human milk fortifier comprising from about 5% to about 50% by weight protein, on a dry weight basis, and optionally a probiotic. At least a portion of the protein is extensively hydrolyzed casein. The concentrated liquid human milk fortifier comprises a solids content of greater than 50% by weight, a pH of from 4.6 to 6.5, and a water activity of less than 0.90.

The present disclosure is further specifically directed to a method of fortifying breast milk. The method comprises mixing a liquid human milk fortifier with breast milk in a volume to volume ratio of 1:10 or less. The liquid human milk fortifier comprises from about 5% to about 50% by weight protein, on a dry weight basis, and optionally a probiotic. At least a portion of the protein is extensively hydrolyzed casein. The liquid human milk fortifier comprises a solids content of greater than 50% by weight and a water activity of less than 0.90.

The present disclosure is further specifically directed to a concentrated liquid nutritional composition comprising from about 5% to about 50% by weight protein, on a dry weight basis, wherein at least a portion of the protein is extensively hydrolyzed casein, and optionally a probiotic. The liquid nutritional composition comprises a solids content of greater than 50% by weight and a water activity of less than 0.90.

In some embodiments, the concentrated liquid human milk fortifier further includes a stabilizer system. In one embodiment, the stabilizer system is comprised of an octenyl succinic anhydride (OSA) modified starch (e.g., OSA modified corn starch) and a low acyl gellan gum. In another embodiment, the stabilizer system is a single stabilizer such as OSA modified potato starch. The stabilizer system allows for the use of the extensively hydrolyzed casein protein without the associated problems of mineral fallout and poor emulsion stability, and allows for the fortifier, in some embodiments, to be carrageenan-free.

It has been unexpectedly found that stable, concentrated liquid human milk fortifiers and concentrated liquid nutritional compositions can advantageously be prepared with a low water activity and/or low pH level. The low water activity, for example, a water activity of less than 0.90, and/or low pH, for example, a pH within the range of 4.6 to 6.5, of the liquid can reduce or even inhibit bacterial growth in the liquid such as from Cronobacter sakazakii, preventing subsequent food spoilage. Moreover, the low water activity and/or low pH provides an environment that hinders the growth of probiotic bacteria such as Bifidobacterium and Lactobacillus species, while maintaining its viability. This improves product consistency and may prevent inconsistent bacterial levels in the gut upon product use due to uncontrolled proliferation of the probiotics followed by die-off over time.

A balanced colonization of probiotics, through both supplementing the concentrated liquids with one or more probiotics and providing the liquids with low water activity and/or low pH to reduce uncontrolled microbial growth, can be provided so as to provide infants, and particularly, preterm infants, with a reduced bowel reservoir of pathogenic microorganisms, a reduced dependence on broad-spectrum antibiotics, an increased gut mucosal barrier to pathogenic bacteria, and an up-regulation in protective immunity. This is especially desirable for low birth weight and preterm infants delivered by caesarean section as these infants may be more at risk for slower development of diverse and beneficial intestinal flora as compared to a naturally born infant. The addition of probiotics further provides protection to the preterm infant against necrotizing enterocolitis and bacterial translocation.

Furthermore, by lowering one or both of water activity and pH of the concentrated liquids of the present disclosure, a sterile liquid may be produced having reduced microbial growth, and thus, greater stability and longer shelf-life without extensive and severe heat treatment. By reducing the severity of heat treatment required to sterilize the concentrated liquids, the need to over-fortify ingredients (e.g., vitamins and minerals), which may be heat sensitive, may be reduced or eliminated. This further can reduce processing costs.

Supplementation with probiotics further provides for improved enteral nutrition, thereby improving weight gain typically desired of low birth weight and preterm infants.

Additionally, it has been unexpectedly discovered that concentrated liquids can be prepared to have higher solids contents; that is, solids contents of greater than 50% by weight, and more preferably, greater than 60% by weight. With a more concentrated liquid, and thus greater caloric density, the dose size required may also be reduced. This will allow for increased cost savings and compact packaging size.

The stable concentrated liquids can further be prepared to include hypoallergenic extensively hydrolyzed casein proteins, which is beneficial for use in low birth weight and preterm infants having sensitive digestive systems. These liquids including extensively hydrolyzed casein proteins can be prepared without disrupting the long term stability or emulsion properties of the liquid. By preparing a concentrated liquid by utilizing a stabilizer system including a octenyl succinic anhydride modified corn starch and low acyl gellan gum (or octenyl succinic anhydride modified potato starch as a sole stabilizer), the concentrated liquid may include up to 100% extensively hydrolyzed casein (by weight of the protein component) while maintaining the desired emulsion and stability properties.

### DETAILED DESCRIPTION

The concentrated liquid compositions, and particularly concentrated liquid human milk fortifiers, of the present disclosure generally comprise extensively hydrolyzed casein, have a high solids content, and a low water activity, and optionally a probiotic. These concentrated liquid human milk fortifiers are long term stable and displace only a minimal amount of volume upon addition to human breast milk and/or infant formula.

The concentrated liquid human milk fortifiers of the present disclosure address and provide a solution to the longstanding problem of providing a sterile, long term stable, hypoallergenic liquid human milk fortifier, optionally including a probiotic, that can be used in combination with human breast milk or infant formula without significant volume displacement. The concentrated liquid human milk fortifiers of the present disclosure not only provide the significant benefit of improved sterility as compared to powdered human milk fortifiers that may potentially be subject to microbial contamination, but also provide a stable human milk fortifier that includes extensively hydrolyzed protein that can be more easily digested and absorbed into the gut of an infant, and particularly a preterm infant, as compared to intact proteins, and optionally includes a probiotic. The previous problems of providing a liquid human milk fortifier with probiotic activity have been overcome in the human milk fortifiers disclosed herein.

By providing a long term stable concentrated liquid human milk fortifier that can be based partly or solely on an extensively hydrolyzed protein component, optionally in combination with a probiotic, the present disclosure now provides a sterile, concentrated liquid product that can be used in neonatal intensive care units in combination with human breast milk or infant formula for preterm and term infants to provide the infant with the additional nutrients, including both protein and minerals, required for growth and maturation. This can now be done with a highly sterile, stable product that is highly concentrated so as to be more like a powdered human milk fortifier from a volume displacement perspective.

These and other elements or limitations of the concentrated liquids and methods of the present disclosure are described in detail hereinafter.

The terms “retort packaging” and “retort sterilizing” are used interchangeably herein, and unless otherwise specified, refer to the common practice of filling a container, most typically a metal can or other similar package, with a nutritional liquid and then subjecting the liquid-filled package to the necessary heat sterilization step, to form a sterilized, retort packaged, nutritional liquid product.

The term “aseptic packaging” as used herein, unless otherwise specified, refers to the manufacture of a packaged product without reliance upon the above-described retort packaging step, wherein the nutritional liquid and package are sterilized separately prior to filling, and then are combined under sterilized or aseptic processing conditions to form a sterilized, aseptically packaged, nutritional liquid product.

The term “infant” as used herein, refers generally to individuals less than about 1 year of age, actual or corrected.

The term “preterm” are used herein refers to those infants born at less than 37 weeks gestation, having a birth weight of less than 2500 g, or both.

The terms “fortifier solids” or “total solids”, unless otherwise specified, are used interchangeably herein and refer to all material components of the compositions of the present disclosure, less water.

The term “hypoallergenic” as used herein means that the concentrated liquid has a decreased tendency to provoke an allergic reaction in a user, such as a preterm or term infant, as compared to non-hypoallergenic liquids.

The term “extensively hydrolyzed’ as used herein refers to protein that has been enzymatically or acidically hydrolyzed to have a degree of hydrolysis of at least 20%. Typically, extensively hydrolyzed proteins exist primarily as di- and tripeptides.

The terms “liquid nutritional composition” and “nutritional liquid” are used interchangeably herein, and unless otherwise specified, refer to nutritional products in concentrated form.

The term “adult nutritional product” as used herein includes formulas for generally maintaining or improving the health of an adult, and includes those formulas designed for adults who need to control their blood glucose.

The terms “stable” and “shelf stable” as used herein means that the concentrated liquid is resistant to separation of the liquid into two or more discernable layers (e.g., a top cream layer and a bottom serum layer) and precipitation/sediment formation on the bottom of a container for a time period after manufacture of at least three months, desirably at least six months, desirably at least twelve months, and more desirably at least eighteen months.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the concentrated liquids of the present disclosure may also be substantially free of any optional or selected ingredient or feature described herein, provided that the remaining concentrated liquid still contains all of the required ingredients or features as described herein. In this context, and unless otherwise specified, the term “substantially free” means that the selected concentrated liquid contains less than a functional amount of the optional ingredient, typically less than 0.1% by weight, and also including zero percent by weight of such optional or selected ingredient.

The concentrated liquids and corresponding manufacturing methods of the present disclosure can comprise, consist of, or consist essentially of the elements and limitations of the disclosure as described herein, as well as any additional or optional ingredients, components, or limitations described herein or otherwise useful in the concentrated liquid.

### Product Form

While discussed primarily as a concentrated liquid human milk fortifier, it should be recognized by one skilled in the art based on the disclosure herein that the concentrated compositions described herein may alternatively be used in liquid nutritional compositions such as for use with suspensions, emulsions or clear or substantially clear liquids. The resulting concentrated liquid nutritional compositions may be used as adult liquid nutritional compositions and/or medicinal liquid nutritional compositions.

The concentrated liquid human milk fortifiers of the present disclosure have a solids content of at least 50%, or even at least 60%, including from about 50% to about 65%, and further including from about 58% to about 62%. The concentrated liquid human milk fortifiers are liquids that are capable of being poured directly from a package containing them into human milk, formula, or mixtures thereof.

The concentrated liquid human milk fortifiers are generally formulated to have a caloric density of at least 1.25 kcal/ml (37 kcal/fl oz), including from about 1.3 kcal/ml (38 kcal/fl oz) to about 5 kcal/ml (149 kcal/fl oz), and also including from about 1.4 kcal/ml (40 kcal/fl oz) to about 2.7 kcal/ml (80 kcal/fl oz), and also including from about 1.5 kcal/ml (44 kcal/fl oz) to about 2.0 kcal/ml (59 kcal/fl oz).

The concentrated liquid human milk fortifiers include packaged compositions further comprising a suitable unit dose package or container. The term “unit dose” as used herein refers to individual, single-use, packages of concentrated liquid human milk fortifier containing an amount of human milk fortifier that can be used in a preparation of an infant feeding to provide sufficient human milk fortifier to supplement human milk for immediate use, e.g., preferably within 8-24 hours, more preferably within 0-4 hours, of mixing with human milk.

The amount of fortified human milk prepared for a premature infant, for example, typically ranges from 25 ml to 150 ml a day. Consequently, a single unit dose is the appropriate amount of fortifier solids to fortify a 25 ml preparation. Multiple packages can be used to prepare larger feeding volumes, especially for term infants.

The amount or volume of concentrated liquid human milk fortifier in each unit dose package includes those embodiments in which the package contains an amount suitable to prepare an infant's next feeding. These unit dose packages typically contain sufficient fortifier to provide from about 0.5 g to about 10 g of fortifier solids, more typically from about 0.8 g to about 7.5 g of fortifier solids, and even more typically from about 0.85 g to about 6.0 g of fortifier solids.

The concentrated liquid human milk fortifiers of the present disclosure are preferably formulated so as to provide fortified human milk having an osmolality of less than about 500 mOsm/kg water, preferably from about 300 mOsm/kg water to about 400 mOsm/kg water. Based on the disclosure herein, one skilled in the art can readily formulate the concentrated liquid human milk fortifier with the appropriate carbohydrate sources and corresponding DE (dextrose equivalence) values to obtain or otherwise provide for the targeted osmolality of the human milk fortifier when combined with human milk.

The concentrated liquid human milk fortifiers are further formulated to have a low water activity sufficient to reduce or inhibit microbial growth, particularly growth of C. sakazakii, Clostridium botulinum, Salmonella spp., Staphylococcus aureus, and Escherichia coli, as well as many food spoilage microorganisms known in the art. Preferably, the liquid human milk fortifiers are prepared to have a water activity of less than 0.90, more preferably less than 0.875, and even more preferably less than 0.86.

The concentrated liquid human milk fortifiers may suitably have a pH ranging from about 3.5 to about 8.0, but are most advantageously in a pH range of from about 4.5 to about 7.5, including from about 4.5 to about 7.0, including from about 4.5 to about 6.7, including from about 4.5 to about 6.5, and including from about 4.5 to about 6.0. In some embodiments, the pH range is from about 5.5 to about 7.3, including from about 5.5 to about 7.0, including from about 5.5 to about 6.5, and further including from about 5.5 to about 6.0. In other embodiments, the pH range is from about 6.2 to about 7.2, including from about 6.2 to about 7.0, and including from about 6.2 to about 6.5.

### Probiotics

The concentrated liquid human milk fortifiers of the present disclosure comprise at least one probiotic. In some embodiments, the concentrated liquid human milk fortifier includes a combination of probiotics (at least two or more different probiotics) such that the fortifier provides a gut colonization of various probiotics from various sources.

Probiotics are live microorganisms thought to be healthy for the host organism. Lactic acid bacteria (LAB) and bifidobacteria are the most common types of microbes used as probiotics. Probiotics maintain the microbial ecology of the gut and show physiological, immuno-modulatory and antimicrobial effects, such that the use of probiotics has been found to prevent and treat gastrointestinal diseases and/or disorders (e.g., NEC), pathogen-induced diarrhea and toxin-producing bacteria, urogenital infections, and atopic diseases.

In order for microbes to exhibit beneficial probiotic effects in vivo, the organisms should survive for extended time periods in the gastrointestinal tract. Therefore, it is desirable that probiotic strains be selected that possess qualities that prevent their rapid removal by gut contraction. Effective probiotic strains are able to survive gastric conditions and colonize the intestine, at least temporarily, by adhering to the intestinal epithelium.

Further, the probiotic selected should be capable of surviving manufacturing of the concentrated liquid human milk fortifier as well as the extended periods of storage of the fortifier. Accordingly, in some embodiments, a heat resistant probiotic strain may be used to withstand the heat treatment(s) typically used in manufacturing of the concentrated liquid human milk fortifier.

Additionally, as the concentrated liquid human milk fortifier has low water activity, the fortifier provides a medium that supports dormancy of the added probiotic. As used herein, “dormant” or “dormancy” refers to a state in which the bacterial cells have negligible activity, but are ultimately culturable; that is, the bacterial cells are in a reversible state of metabolic shutdown. This dormancy state will further protect the probiotic from various processing and storage conditions.

In some embodiments, the probiotic may further be treated to provide the probiotic in a dormant state. By way of example, the probiotic may be in a form such as a freezedried form, an oil droplet, or a bacterial suspension solution to further protect the probiotic. In some embodiments, the probiotic is encapsulated prior to addition to the concentrated liquid human milk fortifier.

Suitable encapsulation technologies are known in the art. Encapsulation agents or materials may include any encapsulation materials known in the art for use with probiotics, including protective hydrocolloids (e.g., pectins, alginates, gums), carbohydrates, starches, cellulose derivatives, proteins (e.g., dairy, egg, vegetable-based proteins), fat and waxes, fat derived compounds (e.g., lecithins, mono and diglycerides), binders, film forming agents, emulsifiers, surface active agents, carriers, dispersing agents, antioxidants and antimicrobials.

Non-limiting examples of probiotic strains for use in the concentrated liquid human milk fortifiers herein include the genus Lactobacillus including L. acidophilus (e.g., L. acidophilus LA-5 and L. acidophilus NCFM), L. amylovorus, L. brevis, L. bulgaricus, L. casei spp. casei, L. casei spp. rhamnosus, L. crispatus, L. delbrueckii ssp. lactis, L. fermentum (e.g., L. fermentum CETC5716), L. helveticus, L. johnsonii, L. paracasei, L. pentosus, L. plantarum, L. reuteri (e.g., L. reuteri ATCC 55730, L. reuteri ATCC PTA-6475, and L. reuteri DSM 17938), L. sake, and L. rhamnosus (e.g., L. rhamnosus LGG and L. rhamnosus HN001); the genus Bifidobacterium including: B. animalis (e.g., B. animalis spp. lactis Bb-12), B. bifidum, B. breve (e.g., B. breve M-16V), B. infantis (e.g., B. infantis M-63 and B. infantis ATCC 15697), B. longum (e.g., B. longum BB536, B. longum AH1205, and B. longum AH1206), and B. lactis (e.g., B. lactis HN019 and B. lactis Bi07); the genus Pediococcus including: P. acidilactici; the genus Propionibacterium including: P. acidipropionici, P. freudenreichii, P. jensenii, and P. theonii; and the genus Streptococcus including: S. cremoris, S. lactis, and S. thermophilus. Particularly preferred probiotics include B. lactis and L. acidophilus.

The probiotics may be present in the concentrated liquid human milk fortifier in a total amount of at least 10³ CFU/mL composition, including from about 10³ CFU/mL composition to about 10¹¹ CFU/mL composition, and including from about 10⁷ CFU/mL composition to about 10¹⁰ CFU/mL composition.

### Extensively Hydrolyzed Casein Protein

The concentrated liquid human milk fortifiers of the present disclosure may include hypoallergenic extensively hydrolyzed casein as a protein source. Generally, the concentrated liquid human milk fortifiers will include at least 35%, including at least 50%, including at least 60%, including at least 75%, including at least 90% and further including about 100% extensively hydrolyzed casein, by total weight of total protein in the concentrated liquid human milk fortifier. In one desirable embodiment of the present disclosure, the concentrated liquid human milk fortifier includes 100% extensively hydrolyzed casein, by total weight of the protein in the concentrated liquid human milk fortifier. In this desirable embodiment, the concentrated liquid human milk fortifier is hypoallergenic. In some embodiments, the concentrated liquid human milk fortifier will include from about 35% to 100%, including from about 50% to 100%, further including from about 75% to 100% extensively hydrolyzed casein, by total weight of protein in the concentrated liquid human milk fortifier. As discussed further below, in some embodiments of the present disclosure, the concentrated liquid human milk fortifiers of the present disclosure may optionally include other hypoallergenic or non-hypoallergenic proteins in addition to the extensively hydrolyzed casein protein.

Extensively hydrolyzed casein proteins suitable for use in the concentrated liquid human milk fortifiers of the present disclosure include those having a degree of hydrolysis of at least 10%, including from about 20% to about 80%, including from about 20% to about 60%, and further including from about 40% to about 60%. Generally, the extensively hydrolyzed casein has a ratio of total amino nitrogen (AN) to total nitrogen (TN) of from about 0.2 AN to 1.0 TN to about 0.4 AN to about 0.8 TN. Suitable commercially available extensively hydrolyzed caseins will generally have a protein level in the ingredient of from about 50% to about 95%, including from about 70% to about 90%. One suitable commercially available extensively hydrolyzed casein is Dellac CE90, which is a spray dried powder casein hydrolysate (Friesland Campina Domo, Amersfoort, The Netherlands).

### Stabilizer System

The concentrated liquid human milk fortifiers of the present disclosure optionally include a stabilizer system. In one embodiment, the stabilizer system is a single stabilizer system including octenyl succinic anhydride (OSA) modified potato starch. In another embodiment, the stabilizer system is a synergistic two component stabilizer system. The first component is an OSA modified starch, such as an OSA modified corn starch or an OSA modified potato starch. The second component is a low acyl gellan gum. These two components act in a synergistic manner to stabilize the concentrated liquid human milk fortifier and retard the precipitation of nutrients therefrom.

The OSA modified starch, including the desirable OSA modified corn starch or OSA modified potato starch, is generally prepared by esterifying a dextrinized, ungelatinized waxy corn or potato starch with 1-octenyl succinic anhydride. Methods of this type are well known in the art. One suitable commercially available OSA modified corn starch is N-CREAMER™ 46 (National Starch Food Innovation, Bridgewater, N.J.). A suitable commercially available OSA modified potato starch is ELIANE™ MC160 (AVEBE, The Netherlands).

The OSA-modified starch is present in the concentrated liquid human milk fortifier in an amount of from about 0.1% to about 3.5%, including from about 0.6% to about 2.0%, including from about 0.8% to about 1.5%, and further including about 1.2% by weight of the concentrated liquid human milk fortifier.

The low acyl gellan gum (also known as and commonly referred to as deacylated gellan gum) may be a water-soluble polysaccharide produced by fermentation of a pure culture of Sphingomonas elodea. As used herein, “low acyl” means that the gellan gum has been treated such that it forms firm, non-elastic, brittle gels, that are heat stable, as compared to “high acyl” which forms soft, very elastic, non-brittle gels. One suitable commercially available low acyl gellan gum is Kelcogel F (CP Kelco U.S. Inc., Atlanta Ga.).

The low acyl gellan gum is present in the concentrated liquid human milk fortifier in an amount of from greater than 125 ppm to about 800 ppm, including from about 150 ppm to about 400 ppm, including from about 200 ppm to about 300 ppm and further including about 200 ppm.

### Macronutrients

The concentrated liquid human milk fortifiers and concentrated liquid nutritional compositions of the present disclosure generally comprise carbohydrate, fat, and protein macronutrients of sufficient types and amounts that, when used alone or in combination with human milk or other feeding formula, help meet the nutritional needs of the user, especially the premature infant. The concentration of these macronutrients in the various embodiments of the present disclosure includes the ranges described hereinafter.

### Protein

The concentrated liquid human milk fortifiers of the present disclosure comprise a protein suitable for use in infants, especially preterm infants, at concentrations ranging from about 5% to about 50%, including from about 20% to about 40%, including from about 5% to about 30%, including from about 10% to about 25%, and also including from about 15% to about 25%, on a dry weight basis. In some embodiments, the protein may be at a concentration of less than 10%, on a dry weight basis. In some desirable embodiments, the protein concentration may be from about 7 to about 15 grams, including from about 9 to about 12 grams of protein per 100 grams of final liquid product.

As noted above, the protein component of the concentrated liquid human milk fortifiers of the present disclosure is at least partially comprised of extensively hydrolyzed casein. In a particularly desirable embodiment of the present disclosure, the protein component of the concentrated liquid human milk fortifier is entirely comprised of extensively hydrolyzed casein. In embodiments wherein additional proteins sources (i.e., one or more protein sources in addition to the extensively hydrolyzed protein source) are to be used in the concentrated liquid human milk fortifier in addition to the extensively hydrolyzed casein (i.e., the concentrated liquid human milk fortifier protein component is not 100% extensively hydrolyzed casein), the fortifier may still be made hypoallergenic by including additional hypoallergenic proteins such as soy protein hydrolysate, whey protein hydrolysate, rice protein hydrolysate, potato protein hydrolysate, fish protein hydrolysate, egg albumen hydrolysate, gelatin protein hydrolysate, pea protein hydrolysate, bean protein hydrolysate, combinations of animal and vegetable protein hydrolysates, and combinations thereof.

In this context, the terms “protein hydrolysates” or “hydrolyzed protein” are used interchangeably herein and include extensively hydrolyzed proteins, wherein the degree of hydrolysis is most often at least 10%, including from about 20% to about 80%, and also including from about 20% to about 60%, even more preferably from about 40% to about 60%. The degree of hydrolysis is the extent to which peptide bonds are broken by a hydrolysis method. The degree of protein hydrolysis for purposes of characterizing the extensively hydrolyzed protein component of these embodiments is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

In other embodiments of the present disclosure, the concentrated liquid human milk fortifier, in addition to the extensively hydrolyzed protein, may include an additional non-hypoallergenic protein source including for example, partially hydrolyzed or non-hydrolyzed (intact) protein, and can be derived from any known or otherwise suitable source such as milk (e.g., casein, whey, lactose-free milk protein isolates), animal (e.g., meat, fish), cereal (e.g., rice, corn), vegetable (e.g., soy, pea, bean), or combinations thereof. The protein can include, or be entirely or partially replaced by, free amino acids known or otherwise suitable for use in nutritional products, non-limiting examples of which include L-alanine, L-arginine, L-asparagine, L-aspartic acid, L-carnitine, L-cystine, L-glutamic acid, L-glutamine, glycine, L-histidine, L-isoleucine, L-leucine, L-lysine, L-methionine, L-phenylalanine, L-proline, L-serine, L-taurine, L-threonine, L-tryptophan, L-tyrosine, L-valine, and combinations thereof.

### Carbohydrate

The concentrated liquid human milk fortifiers of the present disclosure comprise a carbohydrate suitable for use in infants, especially preterm infants, at concentrations most typically ranging up to about 75% by weight on a dry weight basis, including from about 5% to about 50%, and also including from about 20% to about 40%, by weight on a dry weight basis.

Carbohydrates suitable for use in the concentrated liquid human milk fortifiers may include hydrolyzed or intact, naturally and/or chemically modified, starches sourced from corn, tapioca, rice or potato, in waxy or non-waxy forms. Other non-limiting examples of suitable carbohydrate sources include hydrolyzed cornstarch, maltodextrin (i.e., non-sweet, nutritive polysaccharide having a DE value less than 20), corn maltodextrin, glucose polymers, sucrose, corn syrup, corn syrup solids (i.e., polysaccharide having a DE value greater than 20), glucose, rice syrup, fructose, high fructose corn syrup, indigestible oligosaccharides such as fructooligosaccharides (FOS), and combinations thereof. The carbohydrates may comprise lactose or can be substantially free of lactose.

One embodiment of the present disclosure includes a non-reducing carbohydrate component, which may represent from about 10% to 100%, including from about 80% to 100%, and also including 100%, by weight of the total carbohydrate in the concentrated liquid human milk fortifier. The selection of a non-reducing carbohydrate may enhance the product stability and is generally better tolerated by infants, especially premature infants. Non-limiting examples of non-reducing carbohydrates include sucrose or other carbohydrates that do not readily oxidize or react with Tollen's, Benedict's, or Fehling's reagents. The present disclosure therefore includes those embodiments comprising a carbohydrate component, wherein the carbohydrate component comprises a mono- and/or disaccharide such that at least 50%, including from about 80% to 100%, and also including 100%, of the mono- and/or disaccharide is a non-reducing carbohydrate.

### Fat

The concentrated liquid human milk fortifiers of the present disclosure also comprise a fat component suitable for use in infants, especially preterm infants, at concentrations most typically ranging up to about 40% by weight on a dry weight basis, including from about 10% to about 40%, and also including from about 15% to about 37%, and also including from about 18% to about 30%, by weight on a dry weight basis.

Fats suitable for use in the concentrated liquid human milk fortifiers of the present disclosure may include coconut oil, soy oil, corn oil, olive oil, safflower oil, high oleic safflower oil, MCT oil (medium chain triglycerides), sunflower oil, high oleic sunflower oil, structured triglycerides, palm and palm kernel oils, palm olein, canola oil, marine oils, cottonseed oils, and combinations thereof.

Suitable fats for use in the concentrated liquid human milk fortifiers include emulsifiers to help the various fortifier components readily disperse when combined with human milk. Non-limiting examples of suitable emulsifiers include glyceryl monostearate, monoglycerides, diglycerides, distilled monoglycerides, soya bean lecithin, polyoxythylene stearate, polyoxyethylene sorbitan mono-oleate, polyoxyethylene sorbitan monopalmitate, polyoxyethylene sorbitan monostearate, ammonium phosphatides, polyoxyethylene sorbitan monolaurate, citric acid esters of mono and diglycerides of fatty acids, tartaric acid esters of mono and diglycerides of fatty acids, and combinations thereof. Natural soy lecithin is especially useful in this respect.

The fat component of the concentrated liquid human milk fortifier may therefore optionally include any emulsifier suitable for use in infant nutritional products. Emulsifier concentrations in these products may range up to about 10%, including from about 0.5% to about 10%, about 1% to about 10%, even more typically from about 1.5% to about 5%, by weight of the total fat component.

Another aspect of the present disclosure includes those embodiments in which the weight ratio of fat to protein in the concentrated liquid human milk fortifier is at least 0.3, including from about 0.4 to about 5, and also including from about 2 to about 4. These ratios may be helpful in further stabilizing the concentrated liquid human milk fortifier.

The concentrated liquid human milk fortifiers of the present disclosure also include those embodiments that comprise as part of the fat component one or more of arachidonic acid, docosahexaenoic acid, or combinations thereof, alone or in further combination with linoleic acid, linolenic acid, or both.

### Vitamins and Minerals

The concentrated liquid human milk fortifiers of the present disclosure may further comprise any of a variety of vitamins, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof.

The concentrated liquid human milk fortifiers may also further comprise any of a variety of minerals known or otherwise suitable for use in infant or other nutritional formulas, non-limiting examples of which include phosphorus, magnesium, calcium, zinc, manganese, copper, iodine, sodium, potassium, chloride, selenium, and combinations thereof.

The concentrated liquid human milk fortifiers of the present disclosure include those embodiments comprising per 100 kcal of fortifier solids one or more of the following: vitamin A (from about 250 to about 6500 IU), vitamin D (from about 40 to about 1200 IU), vitamin K, vitamin E (at least 0.3 IU), vitamin C (at least 8 mg), thiamine, vitamin B₁₂, niacin, folic acid, pantothenic acid, biotin, choline (at least 7 mg), and inositol (at least 2 mg).

The concentrated liquid human milk fortifiers also include those embodiments comprising per 100 kcal of the fortifier solids one or more of the following: calcium (at least 50 mg), phosphorus (at least 25 mg), magnesium (at least 6 mg), iodine, zinc (at least 0.5 mg), copper, manganese, sodium (from about 20 to about 60 mg), potassium (from about 80 to about 200 mg), chloride (from about 55 to about 150 mg) and selenium (at least 0.5 mcg).

### Other Optional Ingredients

The concentrated liquid human milk fortifiers of the present disclosure may further optionally comprise other ingredients that may modify the physical, chemical, aesthetic or processing characteristics of the compositions or serve as pharmaceutical or additional nutritional components when used in the targeted population. Many such optional ingredients are known for use in food and nutritional products, including infant formulas, and may also be used in the concentrated liquid human milk fortifiers of the present disclosure, provided that such optional materials are compatible with the materials described herein, are safe and effective for their intended use, and do not otherwise unduly impair product performance.

Non-limiting examples of such optional ingredients include preservatives, antioxidants, various pharmaceuticals, buffers, carotenoids, colorants, flavors, nucleotides and nucleosides, thickening agents, prebiotics, probiotics, sialic acid-containing materials, and other excipients or processing aids.

### Aseptic Packaging

In some embodiments, the concentrated liquid human milk fortifiers of the present disclosure may be sterilized and aseptically packaged. The aseptic packaging can be accomplished using any of a variety of techniques well known to those of ordinary skill in the formulation art, so long as the heat treatment is sufficient to achieve long term shelf stability of the concentrated liquid. In one specific example, an aseptic process is utilized that includes a high temperature short time (HTST) processing step (i.e., about 165° F. (74° C.) for about 16 seconds) or an ultra high temperature (UHT) processing step (i.e., about 292° F. (144° C.) for about 5 seconds).

A typical aseptic process in accordance with the present disclosure involves the preparation of a slurry from one or more fluid combinations that may contain water and one or more of the following: carbohydrates, OSA modified starch, extensively hydrolyzed casein protein, fats, vitamins and minerals. This slurry is typically emulsified, deaerated, homogenized and cooled to form a sterilized formula, and then aseptically packaged to form a sterilized, aseptically packaged concentrated liquid human milk fortifier. Various other solutions may be added to the slurry at most any time before, during, or after processing.

Suitable aseptic packaging techniques include any of the well known aseptic packaging methods disclosed in the formulation arts for preparing nutritional formulation, all of which are generally directed to the sealing or filling of a sterilized liquid into a sterilized, air-tight container. Many variations on the basic method exist and are well known to those of ordinary skill in the formulation art, non-limiting examples of which are described in U.S. Pat. No. 6,096,358 (Murdick et al.); U.S. Pat. No. 6,227,261 (Das et al.); and U.S. Pat. No. 6,371,319 (Yeaton et al.), which descriptions are incorporated herein by reference.

The aseptically packaged embodiments of the present disclosure may include any container or package suitable for use with liquid human milk fortifiers and also capable of withstanding aseptic processing conditions (e.g., high temperature sterilization). Non-limiting examples of such containers include single or multi use bags, plastic bottles or containers, pouches, metal cans glass bottles, foil or other flexible pouches, syringes, vials, or any other container meeting the above-described criteria.

The aseptically packaged container for these embodiments is typically sterilized prior to being filled with its sterilized contents. The container is most typically sterilized by the application of hydrogen peroxide or other suitable disinfectant to the inside surface of the container. The hydrogen peroxide or other disinfectant is often applied in an atomized mist. After a disinfectant is applied, the container may be transported along a conveyor system during which time the container may be subjected to one or more sprayings of hot sterilized air, preferably hot, sterilized, dry air. The container is then preferably injected with nitrogen gas. The aseptically prepared container is then aseptically filled with sterilized product and sealed.

For aseptic packaging, the concentrated liquid human milk fortifier is typically heat treated with a high temperature short time (HTST) process or an ultra high temperature (UHT) process to sufficiently reduce the bioburden to allow the products to maintain commercially sterile over an extended shelf-life of the finished product exceeding about 12 months. The treated formula is then homogenized at 1000 psi or higher and aseptically packaged.

In an alternative embodiment, the concentrated liquid human milk fortifiers of the present disclosure may also be sterilized and retort packaged utilizing conventional means known in the art.

### Methods of Use

The concentrated liquid human milk fortifier of the present disclosure is used in combination with human milk, other suitable infant formula, or combination of both, wherein the resulting fortified human milk or fortified infant formula or combination of both has an osmolality suitable for oral administration to an infant. As noted, the osmolality will most typically be less than about 500 mOsm/kg water, more typically from about 300 mOsm/kg water to about 400 mOsm/kg water.

As the solids content of the concentrated liquid human milk fortifier has been increased in some embodiments as described herein, the concentrated liquid human milk fortifier of the present disclosure may be added directly to human milk (or infant formula or a combination of human milk and infant formula) in a volume to volume ratio of about 1:10 or less, including from about 1:11 to about 1:14, and also including from about 1:11 to about 1:12. The ratio is ultimately selected based primarily upon the ingredients and osmolality of the concentrated liquid human milk fortifier and in view of the particular nutritional needs of the infant. The concentrated liquid human milk fortifier may be added directly to every feeding or to a sufficient number of feedings (e.g., once or twice daily) to provide optimal nutrition in view of the particular nutritional needs of the infant.

Human milk or other infant formula, after fortification with the concentrated liquid human milk fortifier will most typically have a caloric density ranging from about 40 kcal/fl oz (1.4 kcal/ml) to about 80 kcal/fl oz (2.7 kcal/ml), with the 56-80 kcal/fl oz formulations (1.9-2.7 kcal/ml) being more useful in preterm infants, and the 40-55 kcal/fl oz (1.4-1.9 kcal/ml) formulations more useful for term infants.

The methods of the present disclosure include methods of providing nutrition to infants, especially preterm infants. As noted herein, preterm infants may especially benefit from the use of human milk fortifiers as the fortifier can provide additional nutrients to the preterm infant when combined with human breast milk and/or infant formula to foster quicker growth and development. In one particular embodiment, nutrition is provided to an infant by the addition of the concentrated liquid human milk fortifier to human milk, infant formula, or combination thereof, followed by the administration of the fortified human milk, infant formula, or combination thereof, to the infant.

Other alternative methods of the present disclosure include using the human milk fortifiers as described herein to fortify human breast milk, infant formula, or a combination of human breast milk and infant formula to provide a fortified nutritional liquid for administration to an infant, and particularly a preterm infant. In one embodiment, human breast milk is fortified by mixing the concentrated human milk fortifier with human breast milk, infant formula, or a combination thereof, in a volume to volume ratio of from about 1:3 to about 1:9.

The methods of the present disclosure also include a method of providing nutrition to users other than infants, such as adults and elderly. This method includes the addition of the concentrated composition to other liquid nutritionals such as suspensions, emulsions or clear or substantially clear liquids. The resulting concentrated liquid nutritional compositions may be used as adult liquid nutritional compositions and medicinal liquid nutritional compositions.

### Manufacture

The concentrated liquid human milk fortifiers of the present disclosure may be prepared in accordance with the methods described hereinafter.

In one embodiment, the concentrated liquid human milk fortifier is prepared by solubilizing and combining/mixing ingredients into a homogeneous aqueous mixture which is subjected to a sufficient thermal treatment and aseptic filling to achieve long term physical and microbial shelf stability. It should be recognized that as the probiotic used in the concentrated liquid human milk fortifier cannot survive the aseptic heat treatment of the below described manufacturing process, the probiotic should be blended in after heat treatment, either by sterile stream or direct addition immediately before filling of a sterilized, air-tight container. Alternatively, the probiotic may be treated for protection against the conditions of heat treatment by encapsulating a thermo-resistant probiotic as described herein. The encapsulated thermo-resistant probiotic may then be included in the concentrated liquid human milk fortifier prior to heat treatment. In yet other embodiments, the probiotic may be included in a separate sterile package from the concentrated liquid human milk fortifier, and may be added to the concentrated liquid human milk fortifier immediately prior to use.

To begin the manufacturing process, macronutrients (carbohydrate, protein, fat, and minerals) are combined in several slurries together and with water. This blend is subjected to an initial heat treatment and then tested to verify proper nutrient levels. Additional detail on this process is provided in the following paragraphs.

An intermediate aqueous carbohydrate-mineral (CHO-MIN) slurry is prepared by heating an appropriate amount of water. With agitation, the following soluble ingredients are added: maltodextrin, potassium citrate, magnesium chloride, potassium chloride, sodium chloride, and choline chloride. The carbohydrate-mineral slurry is held at elevated temperature under agitation until added to the blend.

An intermediate oil slurry is prepared by heating MCT oil and coconut oil to an elevated temperature and then adding distilled monoglycerides with agitation for a minimum of 10 minutes in order for the ingredient to dissolve. Soy oil, vitamin A palmitate, vitamin D₃, alpha-tocopheryl-acetate, phylloquinone, ARA, DHA, and mixed carotenoids are then added with agitation to the oil blend. Insoluble mineral calcium source and ultra micronized tricalcium phosphate are added to the oil. Gellan gum and OSA-modified starch are then added to the oil blend with proper agitation. The oil blend slurry is maintained at an elevated temperature under agitation until added to the blend.

The blend is prepared by combining the ingredient water, casein hydrolysate, all of the CHO-MIN slurry and whole oil blend slurry. The blend is maintained at 120° F. for a period of time not to exceed two hours before further processing.

The blend is then homogenized using one or more in-line homogenizers at pressures from 1000-4000 psig with or without a second stage homogenization from 100-500 psig followed by heat treatment using a UHTST (ultra-high temperature short time, 292-297° F. for 1-30 seconds) process. After the appropriate heat treatment, the batch is cooled in a plate cooler to 33-45° F. and then transferred to a refrigerated holding tank, where it is subjected to analytical testing.

The next step in the manufacturing process involves optionally adding the probiotic along with any desired vitamins, trace minerals and water in order to reach the final target total solids, probiotic, and vitamin/mineral contents. The final batch is filled into a suitable container under aseptic conditions or treated with a terminal sterilization process so the product will be stable at room temperature for an extended shelf-life. Additional detail on this process is provided in the following paragraphs.

A trace mineral/vitamin/nutrient solution (STD1) is prepared by heating water to 80-100° F. and adding the following ingredients with agitation: potassium citrate, ferrous sulfate, zinc sulfate, copper sulfate, manganese sulfate, sodium selenate, pyridoxine hydrochloride, riboflavin, thiamine hydrochloride, cyanocobalamin, folic acid, calcium pantothenate, niacinamide, biotin, m-inositol, nucleotide/choline premix, L-carnitine, L-leucine, L-tryptophan, and L-tyrosine.

A vitamin C solution (STD2) is prepared by adding ascorbic acid to water solution with agitation.

All STD 1 and STD2 solutions are then added to the refrigerated batch, with agitation. The appropriate amount of ingredient dilution water is then added to the batch to achieve a target total solids level of 50-65%. The final batch is then subjected to appropriate thermal treatment, the probiotic is optionally added, and filled into a suitable container under aseptic conditions and processes.

The concentrated liquid human milk fortifiers of the present disclosure may, of course, be manufactured by other known or otherwise suitable techniques not specifically described or shown herein without departing from the spirit and scope of the present disclosure. The present embodiments are, therefore, to be considered in all respects as illustrative and not restrictive and that all changes and equivalents also come within the description of the present disclosure. The following non-limiting examples will further illustrate the formulations and methods of the present disclosure.

### EXAMPLES

The following examples illustrate specific embodiments and/or features of the concentrated liquid human milk fortifiers of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the formulation, unless otherwise specified.

### Examples 1-4

In Examples 1-4, concentrated liquid human milk fortifiers are prepared in accordance with the present disclosure. The ingredients for the concentrated liquid human milk fortifier are shown in the following table. All ingredient amounts are listed as kilogram per approximately 1000 kg batch of product, unless otherwise specified.

| | Example | Example | Example | Example |
|---|---|---|---|---|
| Ingredient (Per 1000 kg) | 1 | 2 | 3 | 4 |
| Ingredient Water | Q.S. | Q.S. | Q.S. | Q.S. |
| Casein Hydrolysate | 221.0 | 221.0 | 221.0 | 221.0 |
| Maltodextrin | 154.7 | 0 | 221.0 | 110.5 |
| Sucrose | 66.3 | 221.0 | 0 | 110.5 |
| MCT Oil | 37.8 | 37.8 | 37.8 | 37.8 |
| Citric Acid | 27.6 | 27.6 | 27.6 | 27.6 |
| Tricalcium Phosphate | 29.6 | 29.6 | 29.6 | 29.6 |
| OSA modified corn starch | 24.0 | 24.0 | 0 | 0 |
| OSA modified potato starch | 0 | 0 | 24.0 | 24.0 |
| Soy Oil | 22.6 | 22.6 | 22.6 | 22.6 |
| Coconut Oil | 13.8 | 13.8 | 13.8 | 13.8 |
| Potassium Citrate | 10.4 | 10.4 | 10.4 | 10.4 |
| Magnesium Chloride | 6.8 | 6.8 | 6.8 | 6.8 |
| Ascorbic Acid | 6.6 | 6.6 | 6.6 | 6.6 |
| ARA Oil | 5.2 | 5.2 | 5.2 | 5.2 |
| DHA Oil | 4.2 | 4.2 | 4.2 | 4.2 |
| Leucine | 3.6 | 3.6 | 3.6 | 3.6 |
| Potassium Chloride | 3.4 | 3.4 | 3.4 | 3.4 |
| Tyrosine | 2.8 | 2.8 | 2.8 | 2.8 |
| Monoglycerides | 780.2 g | 780.2 g | 780.2 g | 780.2 g |
| Sodium Chloride | 690.6 g | 690.6 g | 690.6 g | 690.6 g |
| M-Inositol | 400.0 g | 400.0 g | 400.0 g | 400.0 g |
| Choline Chloride | 320.0 g | 320.0 g | 320.0 g | 320.0 g |
| Tryptophan | 300.0 g | 300.0 g | 300.0 g | 300.0 g |
| Zinc Sulfate | 260.6 g | 260.6 g | 260.6 g | 260.6 g |
| Niacinamide | 254.6 g | 254.6 g | 254.6 g | 254.6 g |
| Vitamin E | 217.4 g | 217.4 g | 217.4 g | 217.4 g |
| L-Carnitine | 200.0 g | 200.0 g | 200.0 g | 200.0 g |
| Gellan Gum | 199.6 g | 199.6 g | 0 g | 0 g |
| Calcium Pantothenate | 120.0 g | 120.0 g | 120.0 g | 120.0 g |
| Ferrous Sulfate | 104.0 g | 104.0 g | 104.0 g | 104.0 g |
| Vitamin A Palmitate | 51.5 g | 51.5 g | 51.5 g | 51.5 g |
| Riboflavin | 30.0 g | 30.0 g | 30.0 g | 30.0 g |
| Thiamin Hydrochloride | 22.0 g | 22.0 g | 22.0 g | 22.0 g |
| Pyridoxine Hydrochloride | 17.8 g | 17.8 g | 17.8 g | 17.8 g |
| Cupric Sulfate | 12.0 g | 12.0 g | 12.0 g | 12.0 g |
| Vitamin D₃ | 12.8 g | 12.8 g | 12.8 g | 12.8 g |
| Lutein | 6.4 g | 6.4 g | 6.4 g | 6.4 g |
| Folic Acid | 2.8 g | 2.8 g | 2.8 g | 2.8 g |
| Beta Carotene | 1880.0 g | 1880.0 g | 1880.0 g | 1880.0 g |
| Biotin | 1720.0 g | 1720.0 g | 1720.0 g | 1720.0 g |
| Manganase Sulfate | 1680.0 g | 1680.0 g | 1680.0 g | 1680.0 g |
| Vitamin K | 570.0 g | 570.0 g | 570.0 g | 570.0 g |
| Sodium Selenate | 88.0 g | 88.0 g | 88.0 g | 88.0 g |
| Vitamin B12 | 80.0 g | 80.0 g | 80.0 g | 80.0 g |

The concentrated liquid human milk fortifier is prepared by solubilizing and combining/mixing ingredients into a homogeneous aqueous mixture which is subjected to a sufficient thermal treatment and aseptic filling to achieve long term physical and microbial shelf stability.

To begin the manufacturing process, macronutrients (carbohydrate, protein, fat, and minerals) are combined in several slurries together and with water. This blend is subjected to an initial heat treatment and then tested to verify proper nutrient levels. Additional detail on this process is provided in the following paragraphs.

An intermediate aqueous carbohydrate-mineral (CHO-MIN) slurry is prepared by heating an appropriate amount of water to 140-160° F. With agitation, the following soluble ingredients are added: sucrose, maltodextrin, potassium citrate, magnesium chloride, potassium chloride, sodium chloride, and choline chloride. The carbohydrate-mineral slurry is held at 130-150° F. under agitation until added to the blend.

An intermediate oil slurry is prepared by heating MCT oil and coconut oil to 150 to 170° F. and then adding distilled monoglycerides with agitation for a minimum of 10 minutes in order for the ingredient to dissolve. Soy oil, vitamin A palmitate, vitamin D₃, vitamin E, vitamin K, ARA-containing oil, DHA-containing oil, lutein, and beta-carotene are then added with agitation to the oil blend. Insoluble mineral calcium source, and ultra micronized tricalcium phosphate is added to the oil. Gellan gum and OSA-modified starch are then added to the oil blend with proper agitation. The oil blend slurry is maintained at 130-150° F. under agitation until added to the blend.

The blend is prepared by combining the ingredient water, casein hydrolysate, all of the CHO-MIN slurry and whole oil blend slurry. The blend is maintained at 120° F. for a period of time not to exceed two hours before further processing.

The blend is then homogenized using one or more in-line homogenizers at pressures from 1000-4000 psig with or without a second stage homogenization from 100-500 psig followed by heat treatment using a HTST (high temperature short time, 165-185° F. for 15-20 seconds) process. After the appropriate heat treatment, the batch is cooled in a plate cooler to 33-45° F. and then transferred to a refrigerated holding tank, where it is subjected to analytical testing.

The next step in the manufacturing process involves adding vitamins, trace minerals, other ingredients, and water in order to reach the final target total solids and vitamin/mineral contents. The final pH of the product prior to thermal treatment is also adjusted. The final batch is filled into a suitable container under aseptic conditions or treated with a terminal sterilization process so the product will be stable at room temperature for an extended shelf-life. Additional detail on this process is provided in the following paragraphs.

A trace mineral/vitamin/nutrient solution (STD1) is prepared by heating water to 80-100° F. and adding the following ingredients with agitation: potassium citrate, ferrous sulfate, zinc sulfate, copper sulfate, manganese sulfate, sodium selenate, pyridoxine hydrochloride, riboflavin, thiamine hydrochloride, vitamin B₁₂, folic acid, calcium pantothenate, niacinamide, biotin, m-inositol, L-carnitine, L-leucine, L-tryptophan, and L-tyrosine.

A vitamin C solution (STD2) is prepared by adding ascorbic acid to a water solution with agitation.

All STD 1 and STD2 solutions are then added to the refrigerated batch, with agitation. The appropriate amount of ingredient dilution water is then added to the batch to achieve a target total solids level of 50.0-60.0%. The final pH of the product prior to thermal treatment is adjusted to >4.6-5.2 by addition of citric acid. The final batch is then subjected to appropriate thermal treatment and filled into a suitable container under aseptic conditions and processes.

### Example 5

In this Example, the concentrated liquid human milk fortifier of Example 1 was prepared and the overall water activity was evaluated. Four replicates of the concentrated liquid human milk fortifier were evaluated using AquaLab CX-2 (Decagon Devices, Inc., Pullman, Wash.).

Prior to evaluating the concentrated liquid human milk fortifier, a standardization check was run on saturated salt solutions of lithium chloride, magnesium chloride, and magnesium nitrate. The salt solutions were compared with distilled water. The results of the standardization check are shown in the table below.

| Saturated | Target | Actual | Temperature |
|---|---|---|---|
| Salt Solutions | Standard | Reading | (° C.) |
| Lithium Chloride | 0.11 | 0.11 | 21.7 |
| Magnesium Chloride | 0.3 | 0.305 | 22.6 |
| Magnesium Nitrate | 0.5 | 0.526 | 21.8 |
| DI Water | 1.0 | 0.995 | 22.1 |

The water activity results of the concentrated liquid human milk fortifier replicates are shown in the table below. As the data indicate, the liquid human milk fortifier has a very low water activity that is sufficient to retard the growth of unwanted microbes during storage.

| Replicate | Reading | Temperature (° C.) |
|---|---|---|
| 1 | 0.858 | 22.7 |
| 2 | 0.875 | 21.9 |
| 3 | 0.862 | 21.8 |
| 4 | 0.865 | 21.8 |
| Average | 0.865 | 22.1 |

### Examples 6-9

Examples 6-9 were made in accordance with examples 1-4, respectively, except Bifidobacterium lactis (probiotic) (1.0 kg) was added to each after the thermal treatment and before the batches are filled into a suitable container under aseptic conditions and processes.

1. A concentrated liquid nutritional composition comprising:
from 5% to 50% by weight protein, on a dry weight basis, wherein at least a portion of the protein is extensively hydrolyzed casein;
wherein the concentrated liquid nutritional composition has a solids content of greater than 50% by weight; and
wherein the concentrated liquid nutritional composition has a water activity of less than 0.90.

2. The concentrated liquid nutritional composition of claim 1, further comprising a probiotic.

3. The concentrated liquid nutritional composition according to claim 1, wherein the composition is at least one of a liquid human milk fortifier and an adult liquid nutritional composition.

4. The concentrated liquid nutritional composition of claim 2, comprising from 10³ to 10¹¹ CFU/mL probiotic.

5. The concentrated liquid nutritional composition according to claim 1, wherein the composition has a pH of from 4.6 to 6.5.

6. The concentrated liquid nutritional composition according to claim 1, further comprising carbohydrate, fat, vitamins, and minerals.

7. The concentrated liquid nutritional composition according to claim 1, wherein the concentrated liquid nutritional composition comprises from 20% to 40% by weight protein, on a dry weight basis.

8. The concentrated liquid nutritional composition according to claim 1, further comprising a stabilizer system comprising an octenyl succinic anhydride modified corn starch and a low acyl gellan gum, wherein the octenyl succinic anhydride modified corn starch is present in an amount of from about 0.1% to about 3.5% by weight of the composition, and wherein the low acyl gellan gum is present in an amount of from greater than 125 ppm to about 800 ppm.

9. The concentrated liquid nutritional composition, according to claim 1, wherein the composition includes a stabilizer system consisting of an octenyl succinic anhydride modified potato starch.

10. A method of fortifying breast milk, the method comprising:
mixing a liquid human milk fortifier with breast milk in a volume to volume ratio of less than or equal to 1:10;
wherein the liquid human milk fortifier comprises from 5% to 50% by weight protein, on a dry weight basis, and wherein at least a portion of the protein is extensively hydrolyzed casein;
wherein the liquid human milk fortifier has a solids content of greater than 50% by weight; and
wherein the liquid human milk fortifier has a water activity of less than 0.90.

11. The method of claim 10, wherein the liquid human milk fortifier further comprises a probiotic.

12. The method of claim 11, wherein the liquid human milk fortifier comprises from 10³ to 10¹¹.

13. The method of claim 12, wherein the probiotic is present in the liquid human milk fortifier in a form selected from the group consisting of freezedried, an oil droplet, a bacterial suspension solution, and encapsulated.

14. The method of claim 10, wherein the liquid human milk fortifier has a pH of from 4.6 to 5.2.

15. The method of claim 10, wherein the liquid human milk fortifier further comprises a stabilizer system comprising an octenyl succinic anhydride modified corn starch and a low acyl gellan gum.

16. The method according to claim 10, wherein the fortified breast milk has a caloric density of from 1.4 kcal/mL to 2.7 kcal/mL.

17. The concentrated liquid nutritional composition according to claim 1, wherein the protein is 100% by weight extensively hydrolyzed casein.

18. The concentrated liquid nutritional composition according to claim 1, wherein the composition has a caloric density of from about 1.25 kcal/mL to about 5 kcal/mL.

19. The concentrated liquid nutritional composition according to claim 6, wherein the composition includes a non-reducing carbohydrate, and the non-reducing carbohydrate comprises from about 10% to 100% by weight of the total carbohydrate in the composition.

20. The concentrated liquid nutritional composition according to claim 8, wherein the composition is aseptically packaged.
